(19) United States
(12) Patent Application Publication
(10) Pub. No.: US 2023/0211559 A1
(43) Pub. Date: Jul. 6, 2023

(54) AUTOMATED PARTS RELEASE AND COLLECTION FOR ADDITIVE MANUFACTURING

(71) Applicant: Formlabs Inc., Somerville, MA (US)

(72) Inventors: Seth P. Berg, Medford, MA (US); Suhyun Oh, Boston, MA (US); Eric Wong, Somerville, MA (US); Samuel k. Porter, Cambridge, MA (US); Nathan Jackel, Raleigh, NC (US); Julian A. Petrillo, West Lafayette, IN (US); Mike Morin, Somerville, MA (US); Sharon Soong, Lexington, MA (US); Douglas Ivanoff, Somerville, MA (US)

(73) Assignee: Formlabs Inc., Somerville, MA (US)

(21) Appl. No.: 18/150,533

(22) Filed: Jan. 5, 2023

Related U.S. Application Data
(60) Provisional application No. 63/266,501, filed on Jan. 6, 2022.

(51) Int. Cl. B29C 64/379; B33Y 40/00

(52) U.S. Cl. CPC B29C 64/379; B33Y 40/00

(57) ABSTRACT

A post-processing device configured to be coupled to a three-dimensional printer. The post-processing device includes a head assembly that includes a release device and a collection device. A rail extends in a first direction, and the head assembly is configured to travel along the rail. The device also includes a pedestal assembly configured to be coupled to a base of the three-dimensional printer, and an opening device for opening a cover of the three-dimensional printer. At a parts collection location on the rail, the release device of the head assembly is configured to engage with a build platform of the three-dimensional printer to release printed parts on the build platform, and the collection device of the head assembly is below the build platform and is configured to collect the released printed parts.

### CROSS REFERENCE TO RELATED APPLICATIONS

This U.S. patent application claims priority under 35 U.S.C. §119(e) to U.S. Provisional Application 63/266,501, filed on Jan. 6, 2022. The disclosure of this prior application is considered part of the disclosure of this application and is hereby incorporated by reference in its entirety.

### TECHNICAL FIELD

The present disclosure relates generally to systems and methods for automated post-printing parts release and collection for additive manufacturing.

### BACKGROUND

Additive fabrication, e.g., three dimensional (3D) printing, provides techniques for fabricating objects, typically by causing portions of a building material to solidify at specific positions. Additive fabrication techniques may include stereolithography, selective or fused deposition modeling, direct composite manufacturing, laminated object manufacturing, selective phase area deposition, multi-phase jet solidification, ballistic particle manufacturing, particle deposition, laser sintering or combinations thereof. Many additive fabrication techniques build parts by forming successive layers, which are typically cross-sections of the desired object. Typically each layer is formed such that it adheres to either a previously formed layer or a build surface upon which the object is built.

In one approach to additive fabrication, known as stereolithography or inverted stereolithography, solid objects are created by successively forming thin layers of a curable polymer resin, typically first onto a build surface and then one on top of another. Exposure to actinic radiation cures a thin layer of liquid resin, which causes it to harden and adhere to previously cured layers and/or to a print substrate (i.e., film layer). As such, the adhesion between the previously formed layer of liquid resin and the print substrate must be separated before forming the next successive thin layer of liquid resin.

Traditionally, after the objects have been successfully printed, a human operator is required to manually remove the objects from the build platform for post-processing steps (e.g., washing and curing). Therefore, manual intervention is needed to prepare the additive fabrication machine for subsequent print tasks, which significantly delays the printing workflow. As a result, an automated post-processing system that removes and collects the printed parts from the additive fabrication machine is highly desired.

### SUMMARY

The present disclosure relates generally to accessories to additive fabrication devices, in particular, system and related methods for automating the parts collection and removal during an additive fabrication process.

One aspect of the disclosure provides a post-processing device configured to be coupled to a three-dimensional printer. The post-processing device includes a head assembly that includes a release device and a collection device. A rail extends in a first direction, and the head assembly is configured to travel along the rail. The device also includes a pedestal assembly configured to be coupled to a base of the three-dimensional printer, and an opening device for opening a cover of the three-dimensional printer. At a parts collection location on the rail, the release device of the head assembly is configured to engage with a build platform of the three-dimensional printer to release printed parts on the build platform, and the collection device of the head assembly is below the build platform and is configured to collect the released printed parts.

Implementations of the disclosure may include one or more of the following optional features. In some implementations the release device includes a first arm and a second arm that may each be configured to travel along a second direction transverse to the first direction. Optionally, the first arm and the second arm may engage the build platform and translate towards each other in the second direction. In some aspects, the first arm and the second arm may engage a release trigger of the build platform at the parts collection location. In other aspects, the collection device includes a first basket unit and a second basket unit that may each be configured to travel along the second direction. The first basket unit and the second basket unit may be configured to travel towards each other to form a basket below the build platform when the head assembly is at the parts collection location. Optionally, the first basket unit and the first arm may form an integrated first part of the head assembly, and the second basket unit and the second arm may form an integrated second part of the head assembly.

In other implementations, the device may include a storage device. The collection device may be configured to move to a parts storage location along the rail to drop the collected printed parts into the storage device. In some aspects, the pedestal assembly may be configured to be folded into the post-processing device. Optionally, the post-processing device may be electrically coupled to the three-dimensional printer.

Another aspect of the disclosure provides a parts removal and collection device for a post-processing system and that is operable with a three-dimensional printer. The parts removal and collection device includes a head assembly that includes a release device and a collection device. A rail extends in a first direction, and the head assembly is configured to travel along the trail. The release device of the head assembly is engaged to release printed parts received by the collection device at a parts collection location along the rail. The device also includes a pedestal assembly configured to be coupled to a base of the three-dimensional printer, and an opening device configured to be selectively coupled to a cover of the three-dimensional printer.

This aspect may include one or more of the following optional features. In some aspects the release device of the head assembly includes a first arm and a second arm that are each operable along the rail in a second direction. The first arm may move proximate to the second arm in the second direction, and the first arm and the second arm may be configured to engage a release trigger of the three-dimensional printer. Optionally, the collection device may include a first basket unit and a second basket unit that may each be operable along the rail in a second direction. The first basket unit and the second basket unit may form a basket at the parts collection location. The device may also include a storage device that receives the printed parts from the collection device at a parts storage location along the rail.

In some implementations the pedestal assembly may include a turntable configured to receive and fixedly couple to the three-dimensional printer. The pedestal assembly may be foldable between a storage position and an operable position. In other aspects, the parts removal and collection device may be configured to be in electrical communication with the three-dimensional printer.

The details of one or more implementations of the disclosure are set forth in the accompanying drawings and the description below. Other aspects, features, and advantages will be apparent from the description and drawings, and from the claims.

### BRIEF DESCRIPTION OF DRAWINGS

Various aspects and examples will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 depicts a perspective view of an illustrative stereolithographic additive fabrication device, according to some examples.

FIG. 2A depicts a perspective view of an illustrative automated parts removal and collection system, according to some examples.

FIG. 2B depicts a perspective view of an illustrative automated parts removal and collection system coupled to an additive fabrication device, according to some examples.

FIG. 3A depicts a side view of an illustrative automated parts removal and collection system, according to some examples.

FIG. 3B depicts a side view of an illustrative automated parts removal and collection system coupled to an additive fabrication device, according to some examples.

FIG. 4A depicts a perspective view of an illustrative parts collection device of an automated parts removal and collection system, according to some examples.

FIG. 4B depicts a front view of an illustrative parts collection device of an automated parts removal and collection system, according to some examples.

FIG. 4C depicts a perspective view of an illustrative parts collection device of an automated parts removal and collection system, and a parts removal system configured to be coupled to an additive fabrication device, according to some examples.

FIGS. 5A-5E depict an illustrative parts removal and collection process performed by a parts collection device, according to some examples.

FIGS. 6A-6C depict illustrative parts collection devices with alternative basket designs, according to some examples.

FIGS. 7A-7K depict an illustrative automated parts removal and collection systems with an alternative design in various configurations, according to some examples.

FIG. 8 depicts multiple illustrative automated parts removal and collection devices coupled to a conveyor mechanism for continuous parts collection, according to some examples.

### DETAILED DESCRIPTION

In additive fabrication, irrespective of the particular mechanism by which layers of material are formed, the material is usually formed on a designated surface usually referred to as a build surface. The build surface is typically part of a component of the additive fabrication device referred to as a build platform. The build platform may, in some additive fabrication devices, be configured to move within the fabrication device so that material can be deposited at an appropriate position on the build surface. For instance, build platforms are frequently configured to move in a vertical direction between the formation of each layer so that a new layer may be formed on top of a previously-formed layer.

Typically in additive fabrication (e.g., inverted stereolithographic three-dimensional (3D) printing), the build platform moves in a vertical direction to lower into a resin basin that includes liquid resin. The resin basin that includes the liquid resin includes a bottom film layer. The basin may be disposed above a curing light that exposes the liquid resin disposed between the film layer and the build surface of the build platform (or previously-formed resin layer) causing the liquid resin to cure on the build surface (or previously-formed resin layer) and adhere to the film layer. Thereafter, the fabrication device separates the newly cured resin layer adhered to the film layer by raising the build platform to a second vertical position, allowing more liquid resin to flow into the space disposed between the build surface and the film layer. The fabrication device iteratively repeats the process described above for each layer of a printed part until the printed part is complete.

After the printed part is complete, a human operator is usually required to manually remove the printed part from the build surface for post processing. For example, the human operator can decouple the build platform from the additive fabrication machine and use tools such as chisels or scrapers to separate the printed part from the build surface. The human operator then leaves the removed part in a washing station (e.g., containing isopropyl alcohol) to wash out any residual resin, and then places the washed part in a curing machine for UV or thermal curing.

While some additive fabrication machines are equipped with automated parts release systems (e.g., Formlabs’ quick release build platform), these systems are only responsible for automating the part release process. Manual intervention is still required to collect the released parts, to place them in post processing stations, and to prepare the additive fabrication machine for new printing tasks. Therefore, a system that automates the parts release, collection, and post processing steps for additive fabrication is highly desired. Such a system removes the requirement of manual intervention after a part is printed, and allows continuous printing on a single additive fabrication machine.

Implementations herein are directed toward systems and methods of automating the parts release, collection, and post-processing steps during additive fabrication. Automating the parts release, collection, and post-processing steps increase the throughput of an additive fabrication device and allows continuous printing without manual intervention.

Following below are more detailed descriptions of various concepts related to, and implementations of, techniques for automating the parts release, collection, and post-processing during additive fabrication. It should be appreciated that various aspects described herein may be implemented in any of numerous ways. Examples of specific implementations are provided herein for illustrative purposes only. In addition, the various aspects described in the implementations below may be used alone or in any combination, and are not limited to the combinations explicitly described herein.

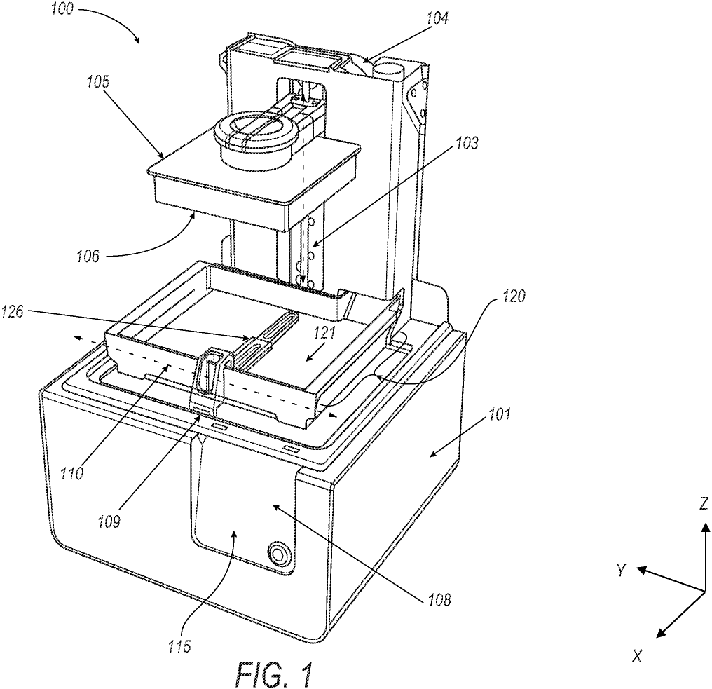

FIG. 1 depicts an illustrative additive fabrication device comprising a basin configured as per any of the implementations discussed below. In some implementations, an illustrative stereolithographic printer 100 includes a support base 101, a display and control panel 108, and a reservoir and dispensing system 104 for storage and dispensing of photopolymer resin (i.e., resin), which may be a liquid. The support base 101, the display and control panel 108, and the reservoir and dispensing system 104 may be removable from the stereolithographic printer 100. The support base 101 may contain various mechanical, optical, electrical, and electronic components that may be operable to fabricate objects using the system. During operation, photopolymer resin (i.e., liquid resin) may be dispensed from the dispensing system 104 into a resin basin (i.e., basin) 120. The basin 120 may be removable from the stereolithographic printer 100. The control panel 108 may include data processing hardware 115 in communication with the control panel 108. The data processing hardware 115 may be in communication with each component of the stereolithographic printer 100. Moreover, a user may provide instructions to the data processing hardware 115 to execute operations on the stereolithographic printer 100 by physically or wirelessly interacting with the control panel 108.

The build platform 105 may be positioned along a vertical axis 103 oriented along the z-axis direction as shown in FIG. 1) such that the downward-facing layer (i.e., lowest z-axis position) of an object being fabricated (not shown), or a build surface 106 itself, is a desired distance along the z-axis from a resin curing surface 121. In the example of FIG. 1, the first build surface 106 is defined on the bottom of the build platform 105 and faces in the -z direction, towards the basin 120. Alternatively, as described in greater detail below, the build surface 106 may refer to a print surface of an attachment to the build platform 105, such as a quick release build platform. The build platform 105 may be removable from the stereolithographic printer 100. For instance, the build platform 105 may be coupled to an arm and may be removed from the printer 100 so that a part attached to the build surface 106 of the build platform 105 can be removed. The build platform 105 may be coupled to the arm via pressure fitting, fastening, or any other practicable coupling methods. In the example of FIG. 1, the resin curing surface 121 is defined on the bottom of the basin 120 and faces in the +z direction towards the build platform 105. The desired distance between the resin curing surface 121 and the build surface 106 may be selected based on a desired thickness of a layer of solid material to be produced on the build surface 106 or onto a previously formed layer of the object being fabricated.

In the example of FIG. 1, the resin curing surface 121 may be transparent to actinic radiation that is generated by a radiation source (not shown) located within the support base 101, such that resin located between the resin curing surface 121 and the build surface 106 or the object being fabricated thereon may be exposed to the radiation. Upon exposure to such actinic radiation, the resin may undergo a chemical reaction, sometimes referred to as curing, that substantially solidifies and attaches the exposed resin to the build surface 106 or to the object being fabricated thereon. FIG. 1 represents a configuration of the stereolithographic printer 100 prior to formation of any layers of an object on build surface 106 and, for clarity, also omits any resin within the depicted basin 120.

Following the curing of a layer of material, build platform 105 may be moved along the vertical axis of motion 103 in order to reposition the build surface 106 for the formation of a new layer onto the build surface 106 itself, or on a previously formed layer. The formation of a new layer may require the imposition of separation forces on any bond of the build surface 106, or a previously formed layer and the resin curing surface 121. Once the separation occurs between the build surface 106, or a previously formed layer, and the resin curing surface 121, additional resin may be dispensed to fill the distance between the desired distance set between the build surface 106, or a previously formed layer, and the resin curing surface 121, such that an additional layer may be formed. In addition, the basin 120 is mounted onto the support base 101 such that the stereolithographic printer 100 may move the basin along horizontal axis of motion 110, the motion thereby advantageously introducing additional separation forces in at least some cases. The basin 120 may include a wiper 126 that is additionally provided, capable of motion along the horizontal axis of motion 110 and may be removably or otherwise mounted onto the support base 101 at 109.

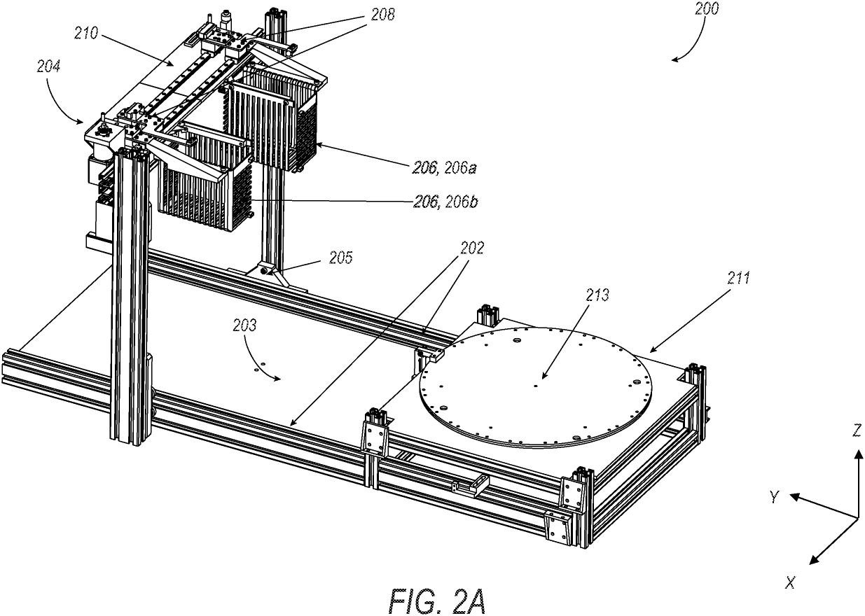

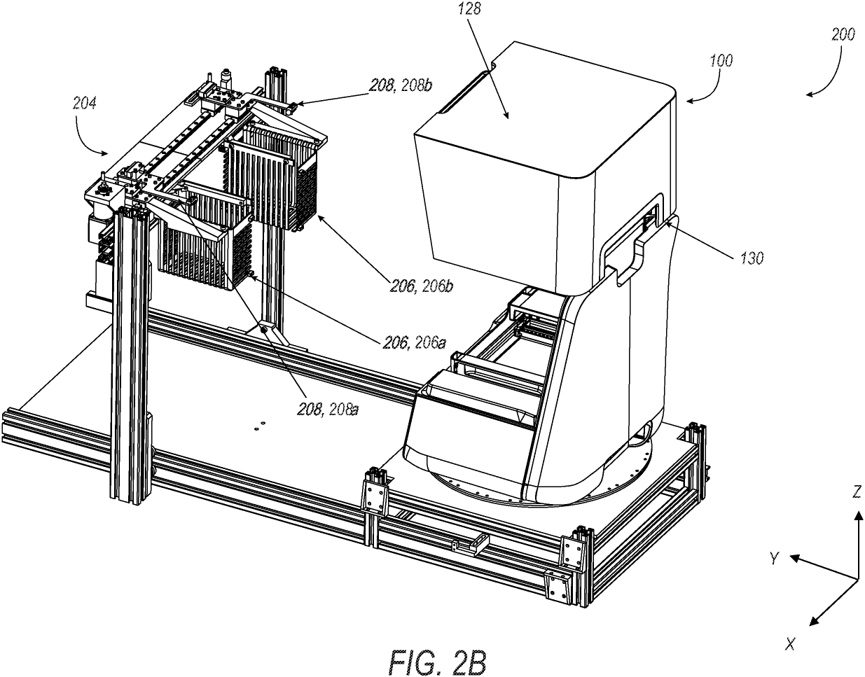

FIG. 2A depicts a perspective view of an illustrative post-processing device or automated parts removal and collection device 200, according to some examples. In some examples, the automated parts removal and collection device 200 includes a base 203 and a head assembly 204. The base 203 includes base rails 202 extending in the y-direction. The head assembly 204 is coupled to the base rails 202 and configured to move on the base rails 202. The base 203 also includes a pedestal assembly 211 and, optionally, a turntable 213 on the pedestal assembly 211, to which a 3D printer (e.g., the stereolithography printer 100 of FIG. 1) is configured to be fixedly attached. The printer 100 may be attached via bolts, screws, magnetic coupling, or any other practicable fastener. In some examples, the base rails 202 may be linear rails and the head assembly 204 includes sliding blocks 205 that are configured to slide along the linear rails. The head assembly 204 is configured to move along the base rails 202 by motorized means (not shown in FIG. 2A), and is configured to stop at preset locations along the base rails 202 to perform specific tasks, such as part release or part collection with respect to the coupled 3D printer.

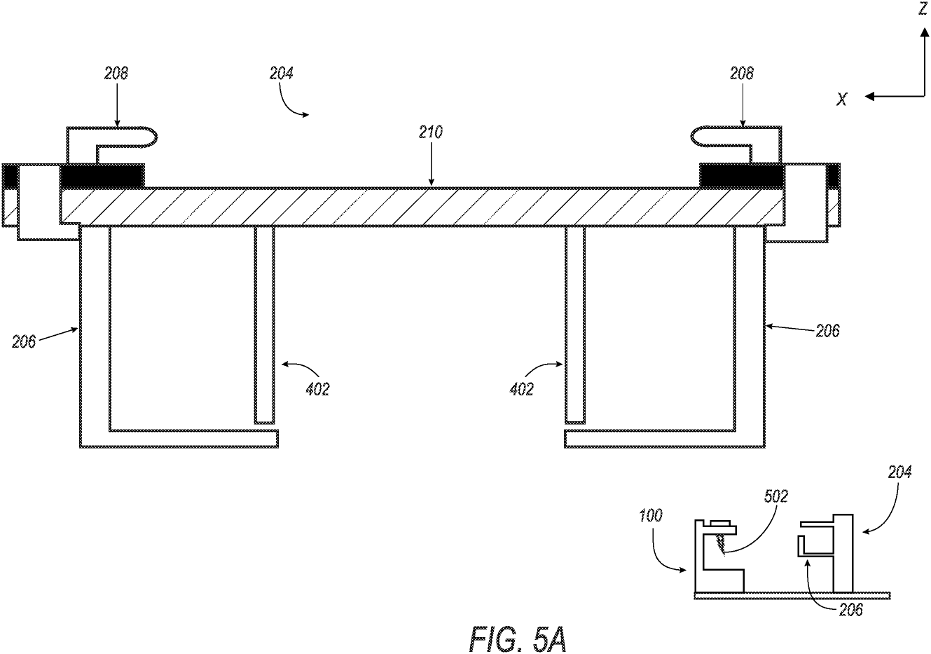

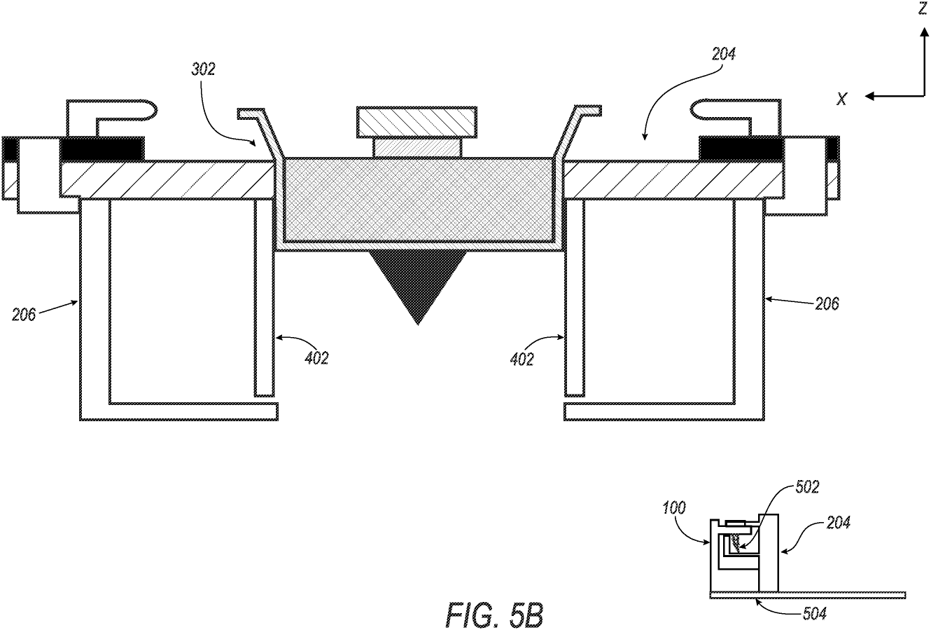

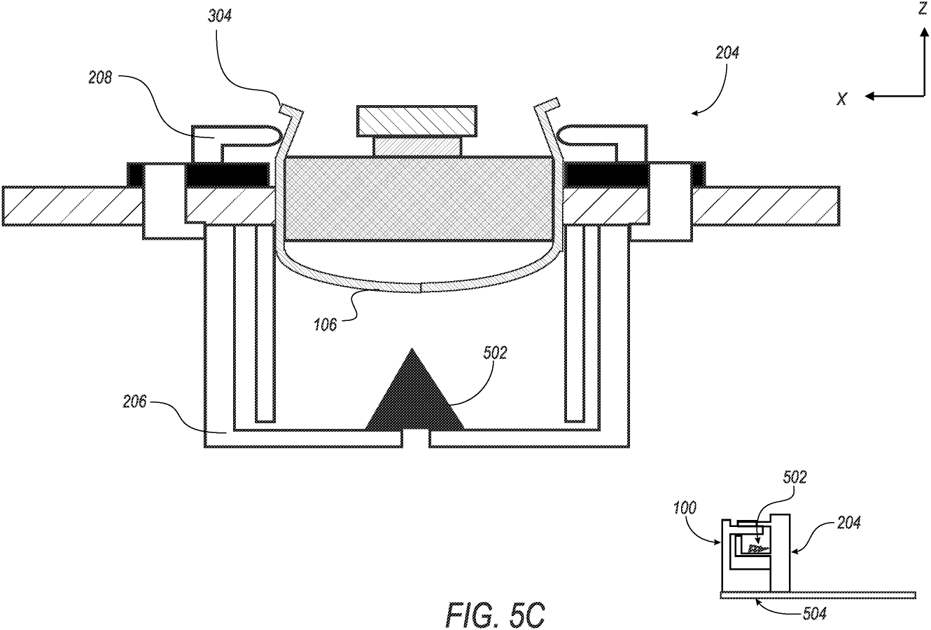

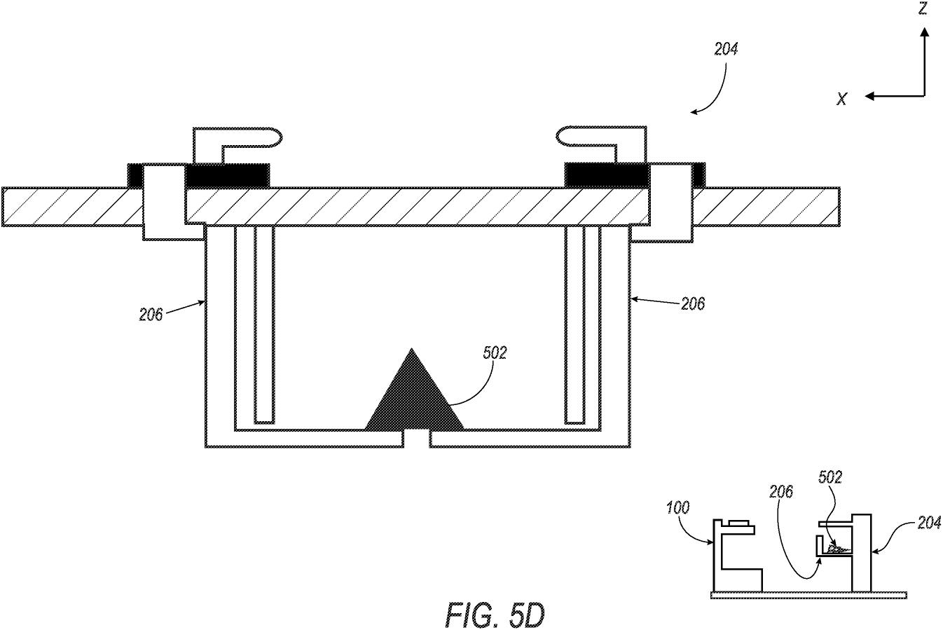

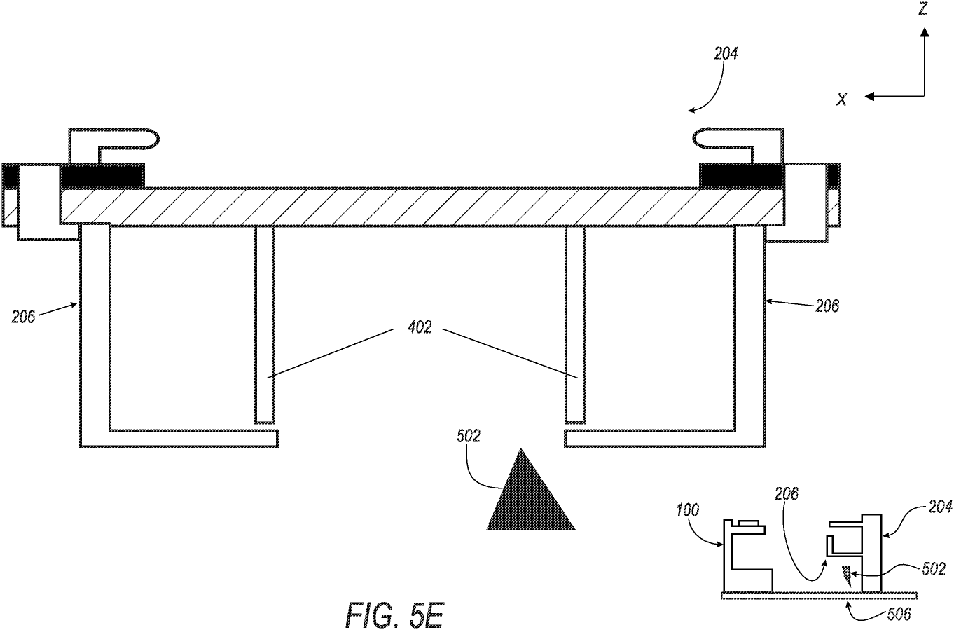

The head assembly 204 includes a collection device 206, a release device 208, and head rails 210 extending along the x-direction. According to some examples, the collection device 206 may be made up of two units that may come together by sliding along the head rails 210 via the motorized mechanisms to form a closed collection device, as descried below with respect to FIGS. 5A-5E. Similarly, the release device 208 may also be made up of two units 206a, 206b that may move inwards towards each other via sliding along the head rails 210 by the motorized mechanisms. In some examples, the collection device 206 includes two basket units 206a, 206b that are configured to move in sync towards or away from each other along the head rails 210 in the x-direction. The two basket units 206a, 206b meet in the middle of the head rails 210 to form a complete basket 206. Similarly, the release device 208 includes two individual arms 208a, 208b that are configured to move in sync towards or away from each other along the head rails 210. In some implementations, each basket unit 206a, 206b of the collection device 206 and a corresponding arm 208a, 208b of the release device 208 are coupled to a common sliding block 404 configured to slide along the head rails 210. Alternatively, each basket unit 206a, 206b of the collection device 206 and arm 208a, 208b of the release device 208 may be coupled to separate sliding blocks and can experience independent movements. For example, each arm 208a, 208b may travel along the rails 210 a direction transverse to the direction of the rails 202.

To automate the parts removal and collection process, the head assembly 204 first moves to a parts collection location 504 along the base rails 202. For example, the parts collection location 504 may be a location at which the collection device 206 is placed below the build platform 105 and the printed part 502, and the release device 208 is placed next to a release trigger of the build platform 105, such that the release device 208 is able to actuate the release trigger as the release device 208 slides along the base rails 202. In some examples, the head assembly 204 is configured to move in the z-direction with respect to the coupled 3D printer (e.g., on the turntable 213). The release trigger may be any mechanism that aids in the removal of a printed part 502 from the build surface 106, such as a quick release build platform. The process of automating the release and collection of printed parts will be described in more detail with respect to FIGS. 5A-5E.

The parts removal and collection device 200 is designed to work with different types and styles of 3D printers (e.g., inverted stereolithography 3D printers). As different 3D printers have different geometric dimensions, the head assembly 204 can be reconfigured (e.g., independently moving the collection device 206, the release device 208, or both in the x, y, or z directions) to accommodate the dimension of the coupled 3D printers and the location of the build platform. For example, for a taller 3D printer, the head assembly 204 can be moved in the z-direction such that the release arms 208a, 208b of the release device 208 can reach the triggering mechanism of the build platform 105.

FIG. 2B depicts the same automated parts removal and collection device 200 as in FIG. 2A, and additionally shows an additive fabrication device 100 (also known as a 3D printer) fixedly coupled to the turntable 213 on the pedestal assembly 211. The additive fabrication device 100 may be coupled to the turntable 213 via bolts, screws, magnetic coupling, or any other practicable fastener. Although not shown in FIG. 2B, the automated parts removal and collection device 200 may include a cover opening device that is configured to open or close a cover 128 (shown in an open state) of the additive fabrication device 100. The cover opening device may include an electric linear actuator, an pneumatic air cylinder, or other pneumatic system. In some examples, one end of the cover opening device may be fixed on the base 203 (e.g., by bolts, screws, magnetic coupling, etc.). As the cover opening device extends or retracts in response to movement of the electric linear actuator, the cover 128 pivots around hinges 130 on the additive fabrication device 100 to close or open. When the cover 128 opens, the head assembly 204 can move to the parts collection location 504, such as, for example, at a location within the space of the additive fabrication device 100 such that the basket units 206a, 206b of the collection device 206 are placed below the build surface 106. Once coupled to the turntable 213, the additive fabrication device 100 can be rotated for a user to easily access the control panel 108.

In some examples, the parts removal and collection device 200 electronically controls the turntable 213 to control the orientation of the additive fabrication device 100. For example, the additive fabrication device 100 may be facing in the x-direction during printing for users to easily access the control panel 108 and then may be rotated to face the head assembly 204 for parts removal and collection. The additive fabrication device 100 is electronically coupled to the parts removal and collection device 200 to share data and power. For example, the parts removal and collection device 200 may be in electrical communication with and provide power to the additive fabrication device 100. An added benefit of controlling the turntable is that the parts removal and collection device 200 may be free from a built-in display and can instead utilize the control panel 108 of the additive fabrication device 100 for user inputs.

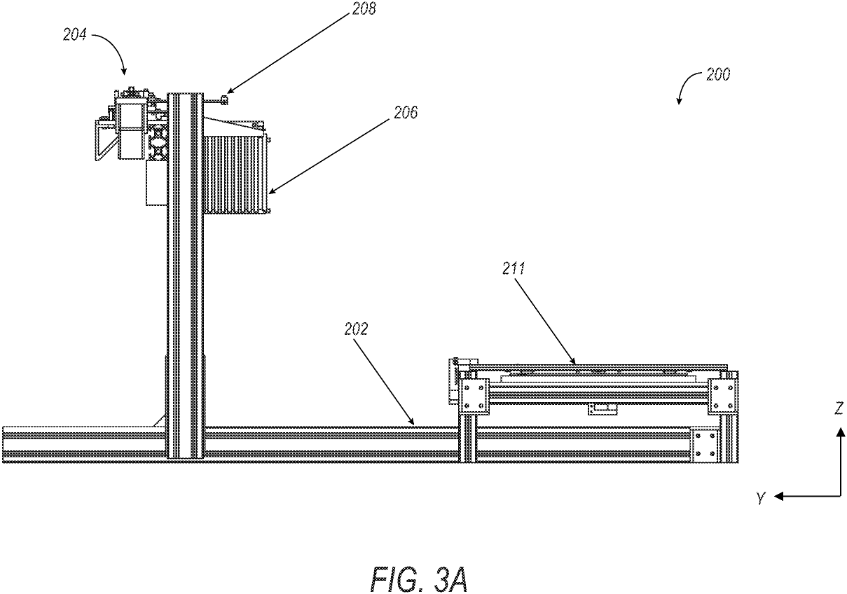

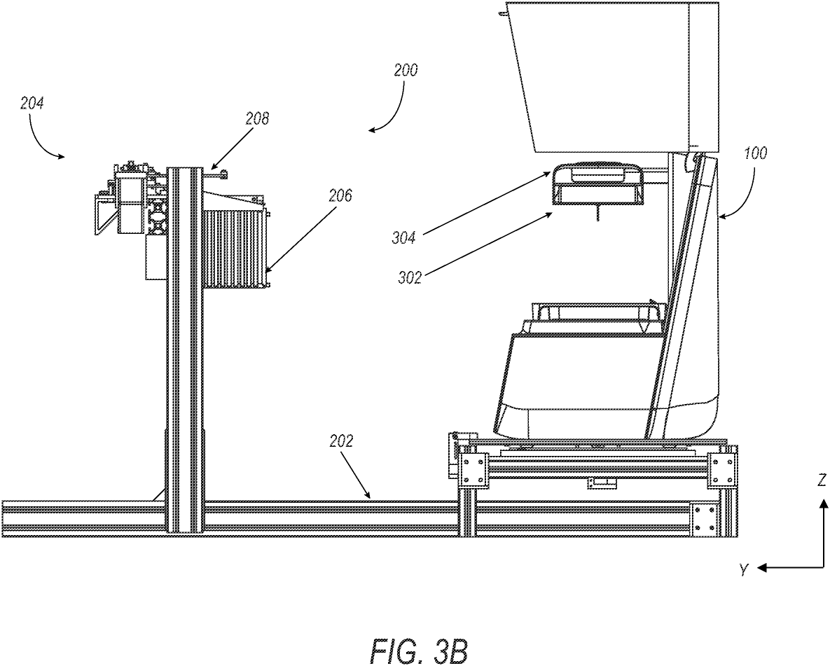

FIGS. 3A and 3B depict side views of the automated parts removal and collection device 200 depicted in FIG. 2A. In addition, FIG. 3B shows the side view of the additive fabrication device 100 of FIG. 1, with the cover 128 in an open state, coupled to the parts removal and collection device 200. FIG. 3B also shows a build platform release device 302 of the build platform 105. The build platform release device 302 includes handle triggers 304, which cause deformation of the build surface 106 of the build platform release device 302 when actuated, such that a fabricated object has a weaker connection to the build surface 106 and may be released from the print surface. When using the build platform release device 302, the build surface 106 refers to a print surface of an attachment to the build platform 105, or a replacement platform, where the printing surface is functionally equivalent to the build surface 106 of the build platform 105 shown in FIG. 1.

When the head assembly 204 moves to the part collection location 504 along the base rails 202, the collection device 206 is directly below the build surface 106, and the release device 208 is ready to be engaged with the handle triggers 304. In one example of the automated parts removal and collection device 200 of FIG. 2A each basket unit 206a, 206b of the collection device 206 and each arm 208a, 208b of the release device 208 move towards the other units (e.g., along the x-axis) on the head rails 210 to actuate the release and collection process. As a result, the arms of the release device 302 squeeze the handle triggers 304 causing the printed part to release from the build platform release device 302. Further, the two basket units 206a, 206b of the collection device 206 come together to form a basket and catch the released printed part 502. With the printed part 502 in the collection device 206, the automated parts removal and collection device 200 may move along the base rails 202 to transport the printed part to another location at which the collection device 206 may open to drop the printed part.

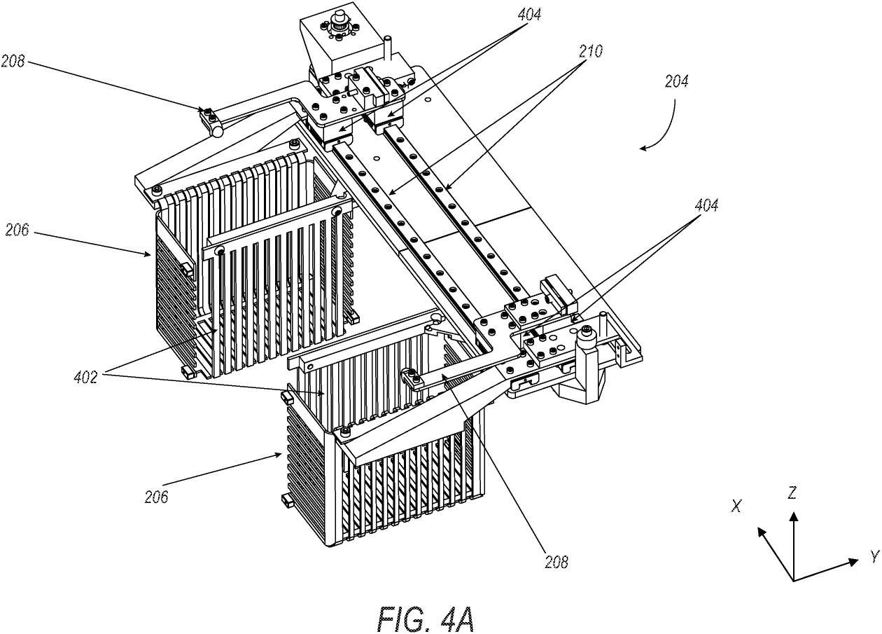

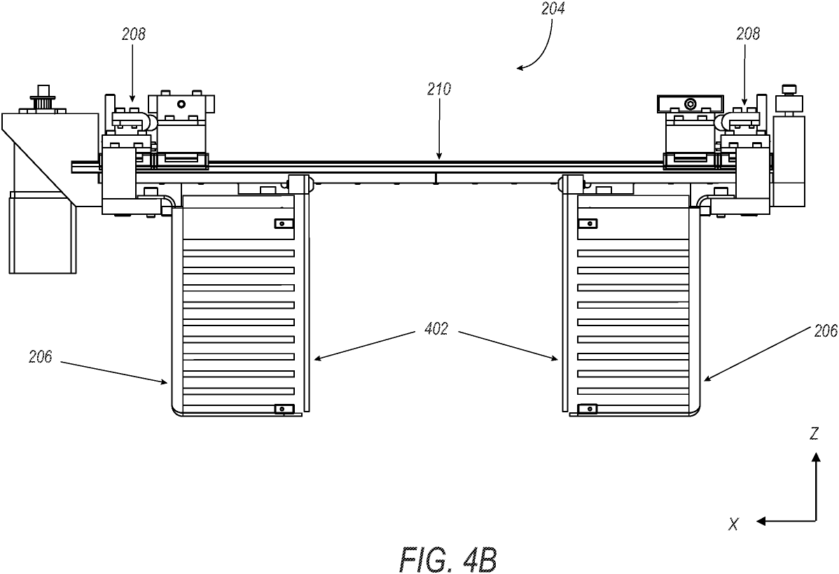

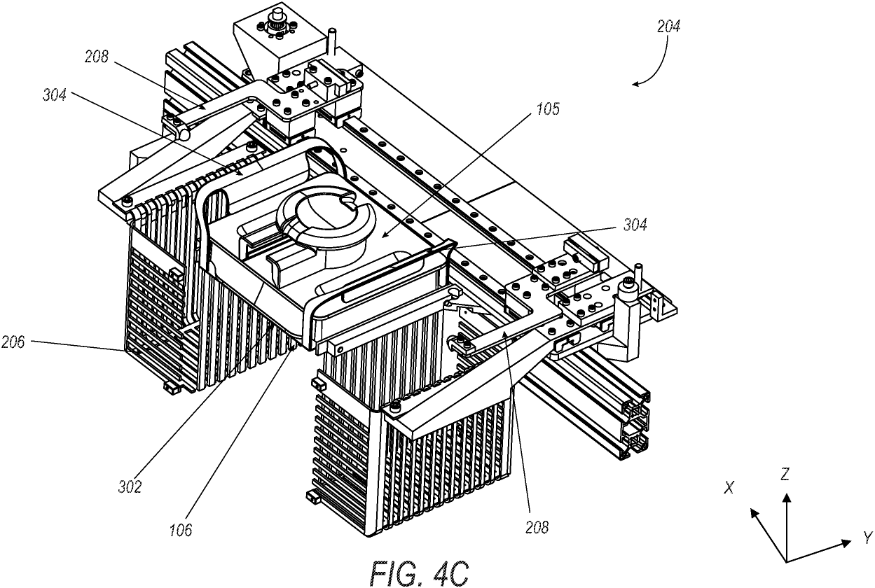

FIG. 4A depicts a perspective view of an illustrative head assembly 204, according to some examples. The head assembly 204 may contain all elements as described for the automated parts removal and collection device above in FIGS. 2A-2B. In FIG. 4A, the head assembly 204 includes the release device 208 and the collection device 206. Both respective elements of the release device 208 and the collection device 206 are fixedly attached to sliding blocks 404, which are configured to slide along head rails 210. In some examples, both the collection device 206 and the release device 208 are attached to the same sliding blocks 404 and are configured to move in sync. In other examples, the collection device 206 and the release device 208 are attached to different sliding blocks 404 and are configured to move independently of each other.

FIG. 4B depicts a frontal view of the illustrative head assembly 204. The head assembly 204 of FIG. 4A includes fixed walls 402 on the path of the sliding collection device 206. The fixed walls 402 may be fixedly attached to the head assembly 204. By way of example, not limitation, the fixed walls may be perpendicular or at an angle to the head rails 210 and are used to facilitate the removal of printed parts (e.g., dropping printed parts into washing or curing stations) from the collection device 206. For example, the printed parts may be dropped into washing or curing stations from the collection device 206. Without the fixed walls 402, the printed part may stay on the collection device 206 without being dropped as the collection device 206 opens (e.g., each basket unit 206a, 206b moving away from each other). The fixed walls 402 effectively push the printed part off the collection device 206 as the collection device 206 opens.

FIG. 4C shows a perspective view of the parts collection device 206, engaging with a quick release build platform 302 with release handles 304, at the parts collection location 504. Note that the rest of the additive fabrication device 100 is not illustrated in FIG. 4C. The parts collection location 504 may be predetermined based on the dimension of the additive fabrication device 100 and the automated parts removal and collection device 200 or by using a location sensor attached to the automated parts removal and collection device 200. For example, the head assembly 204 will dynamically determine the parts collection location 504 along the base rails 202 based on feedback from the location sensor. To release the printed parts, the release device 208 moves towards the handles 304 and biases the handles 304. As a result, the quick release build platform 302 deforms on the build surface 106 and causes the printed part to fall. As the release device 208 moves towards the handles 304, each basket unit 206a, 206b of the collection device 206 moves towards each other to form a basket below the build surface 106, and catches the fallen printed part. This process is described in more detail with respect to FIGS. 5A-5E below.

FIGS. 5A-5E depict an illustrative parts removal and collection process performed by the head assembly 204 (shown in FIGS. 4A-4C), according to some examples. The parts removal and collection process can be achieved without human supervision or interaction and allows an additive fabrication device to achieve continuous printing with minimal downtime.

In FIG. 5A, an object 502 has been printed using the additive fabrication device 100 and is ready for collection. The additive fabrication device 100 is fixedly coupled (e.g., bolts, magnetically coupled, etc.) to the pedestal assembly 211 (e.g., on the turntable 213). The head assembly 204 first controls a cover opening device (e.g., an actuating device, such as a pneumatic air cylinder that is pivotally coupled to the cover of the additive fabrication device 100) to open the cover of the additive fabrication device 100. FIGS. 5A-5E illustrate the additive fabrication device 100 with the cover removed for illustrative purposes only, and it is assumed to be open unless otherwise stated.

In FIG. 5B, once the cover of the additive fabrication device 100 has opened, the parts release and collection device 200 moves towards additive fabrication device 100 and stops at the parts collection location 504 along the base rails 202. The parts collection location 504 may be predetermined based on the dimension of the additive fabrication device 100 and the head assembly 204. Additionally or alternatively, the parts collection location 504 may be determined dynamically based on a location sensor measuring a distance between the additive fabrication device 100 and the head assembly 204. At the parts collection location 504, the head assembly 204 engages with the quick release build platform 302 as shown in FIG. 4C.

As illustrated in in FIG. 5C, the head assembly 204 actuates the quick release build platform 302, as both arms 208a, 208b of the release device 208 and the basket units 206a, 206b of the collection device 206 move toward the quick release build platform 302. As the arms of the release device 208 press the handle 304 of the quick release build platform 302, the build surface 106 of the quick release build platform 302 deforms and causes the printed part to drop. The two basket units 206a, 206b of the collection device 206 form a basket to catch the dropped print.

With reference to FIG. 5D, the head assembly 204 moves away from the additive fabrication device 100 after the printed part 502 has been caught in the collection device 206 in a closed form. At this point, the head assembly 204 may control the cover 128 (FIG. 2B) of the additive fabrication device 100 and cause the cover 128 to close (e.g., using an electric linear actuator attached to the printer cover.) and Once the cover 128 is closed, the head assembly 204 may start a new print task. Comparing to traditional manual parts removal, the automated parts removal process, using the process described here using the automated parts release and collection device, allows new print tasks to start immediately without human intervention, which significantly increases throughput of the additive fabrication device 100.

In FIG. 5E, the head assembly 204 moves to a parts drop location 506 along the base rail 202 to drop the printed part 502, which may be predetermined or determined dynamically. By way of example, not limitation, the parts drop location 506 may be dynamically determined based on a location sensor measuring a distance between the additive fabrication device 100 and the head assembly 204. For example, the head assembly 204 may drop the printed part to a storage basket or to additional post-processing stations such as washing or curing stations. To drop the printed part, each basket unit 206a, 206b of the collection device 206 moves away from each other. The fixed walls 402 prevent the printed part 502 from staying on the floor of the collection device 206 and bias the printed part 502 from the collection device 206. The parts removal and collection device 200 may also include a storage device (not shown) that receives the printed parts from the collection device 206 at a parts storage location along the rail 202.

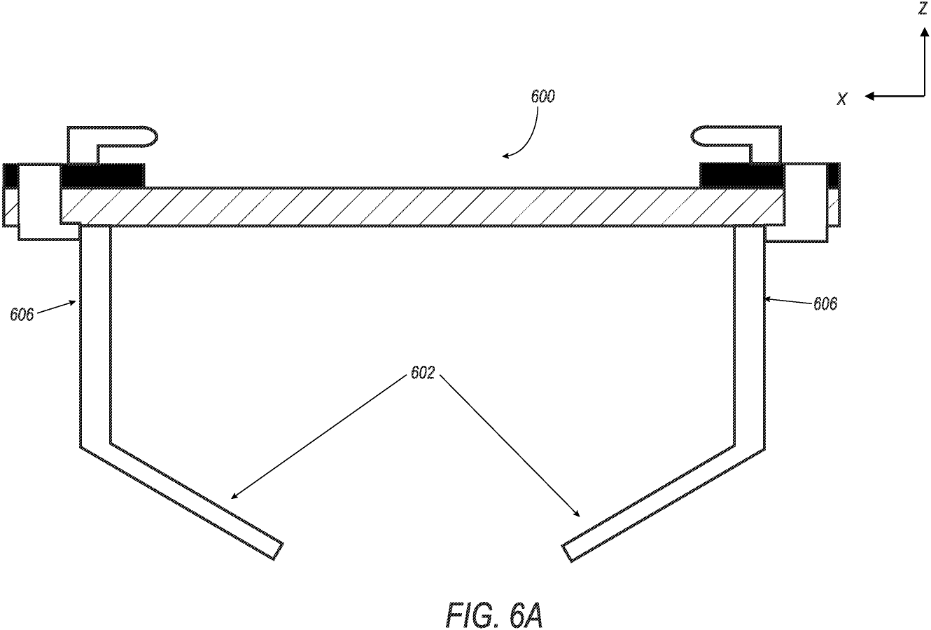

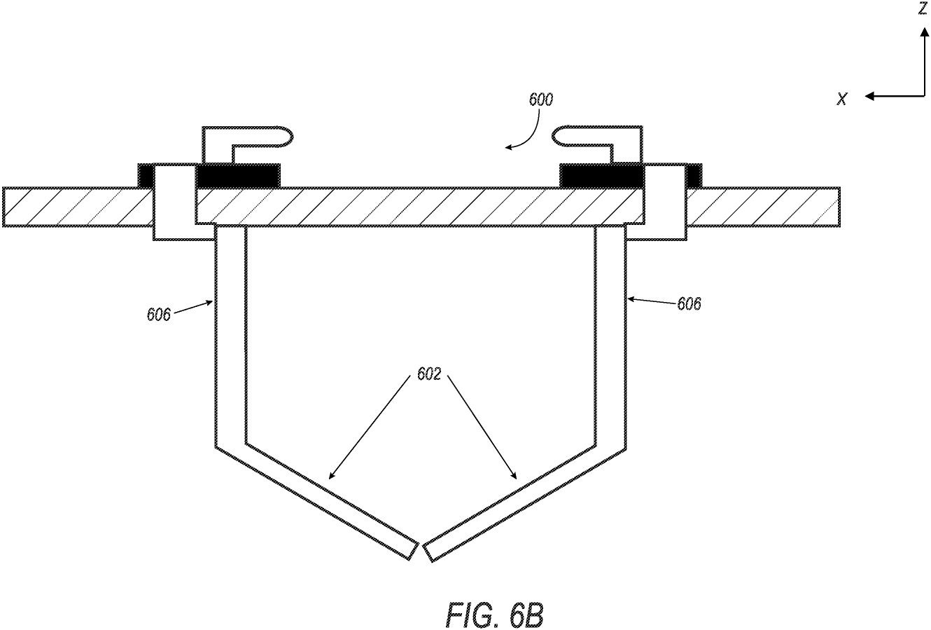

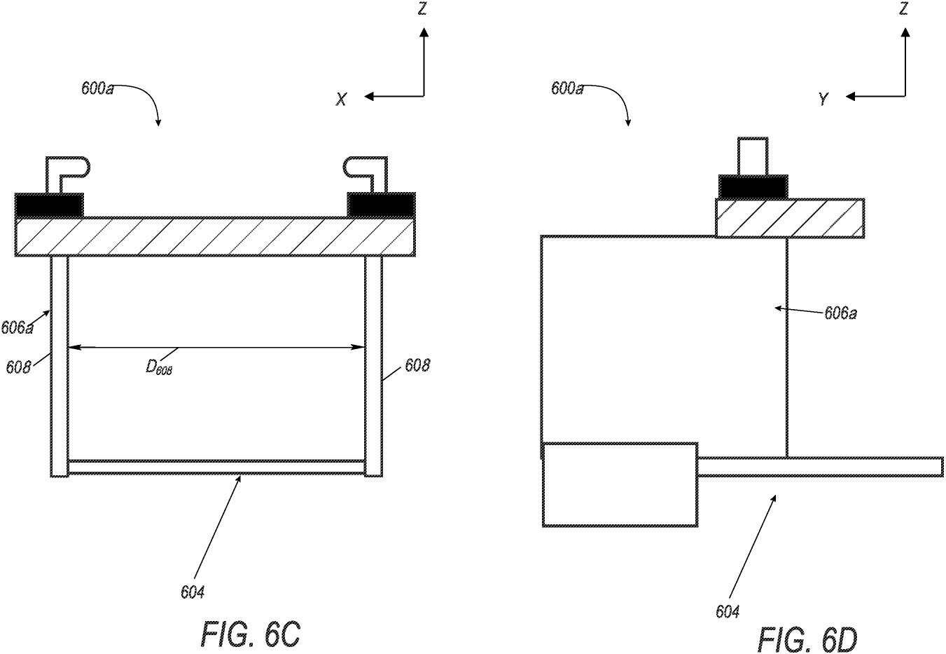

FIGS. 6A-6B depict illustrative head assembly devices with alternative basket designs, according to some examples. FIGS. 6A-6B shows a head assembly device 600 without fixed walls 402 as shown in FIG. 4B, but instead having sloped floors 602 on the collection device 606. As a result, as the collection device 606 opens, the printed part will slide down the sloped floor 602 without being stuck on the collection device 606.

With specific reference to FIGS. 6C and 6D, an alternative head assembly 600a is illustrated. Here, a collection device 606a has a movable floor 604 that may slide to close or open the basket. For example, in FIG. 6D, the head assembly 600a includes a pair of sidewalls 608 that are at a fixed distance D₆₀₈ relative to each other, while the floor 604 spans the distance between the sidewalls 608 to obstruct a lower opening of the head assembly 600a. As shown in FIG. 6D, the floor 604 translates along the y-direction to at least partially open the lower portion of the head assembly 600a, thereby allowing a printed part 502 to drop from the head assembly 600a through the opening. Although not shown, the head assembly 600a may include at least one fixed element for biasing the printed part 502 from an upper surface of the floor 604 when the floor 604 is moved to the open position (FIG. 6D).

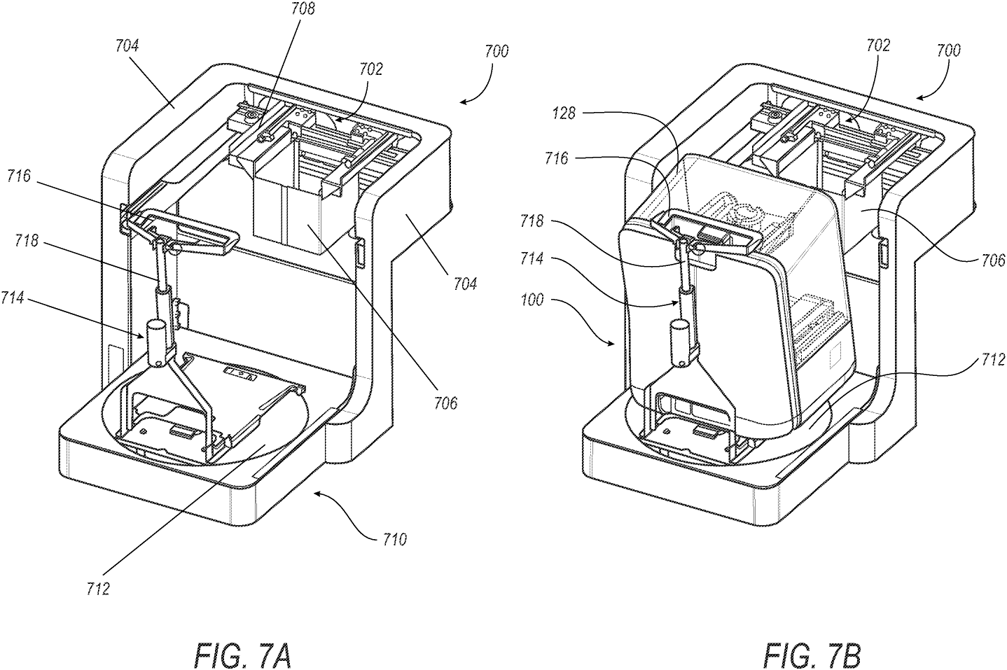

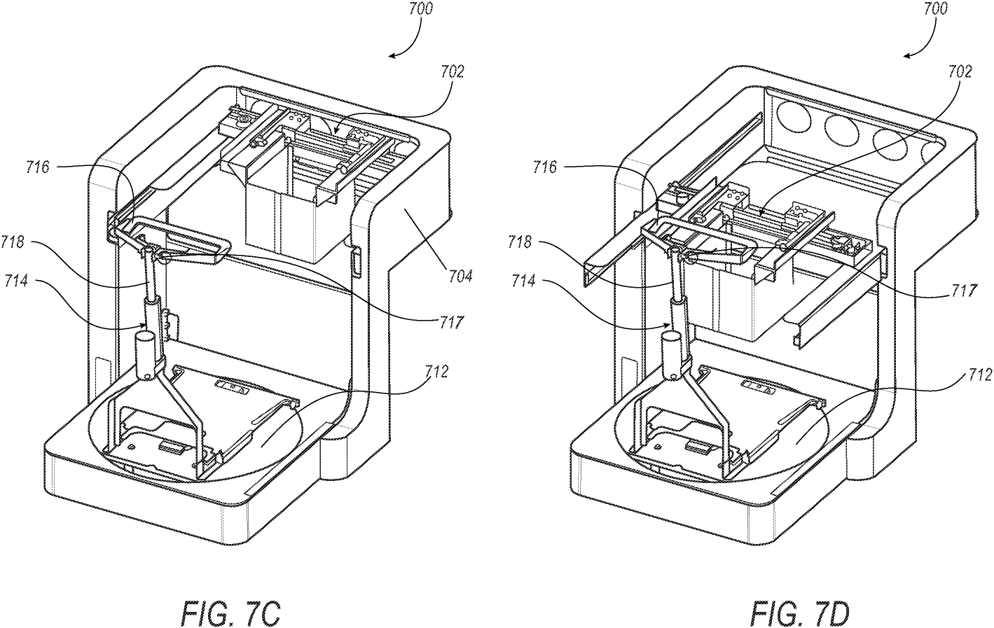

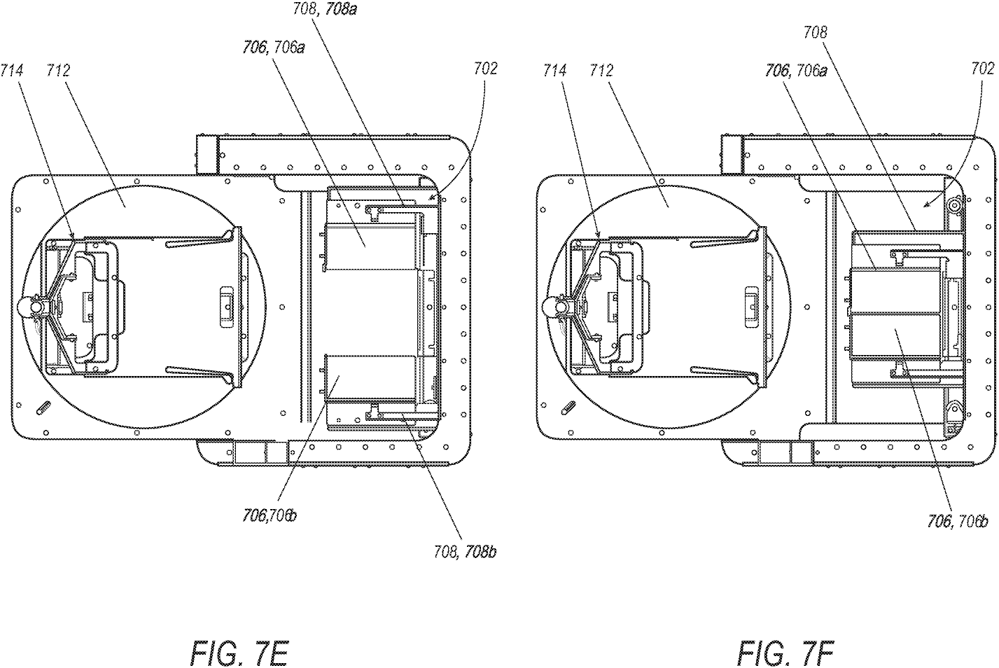

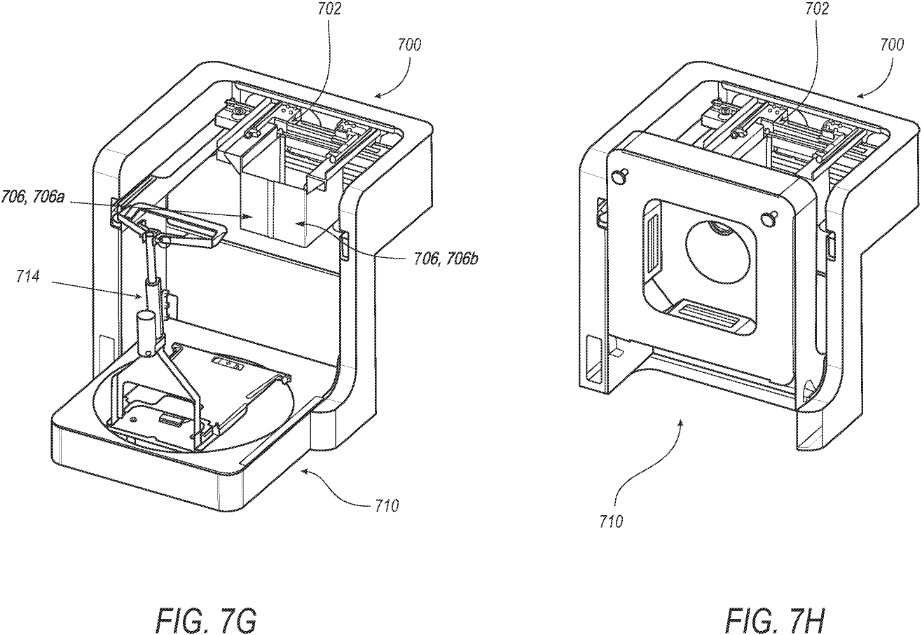

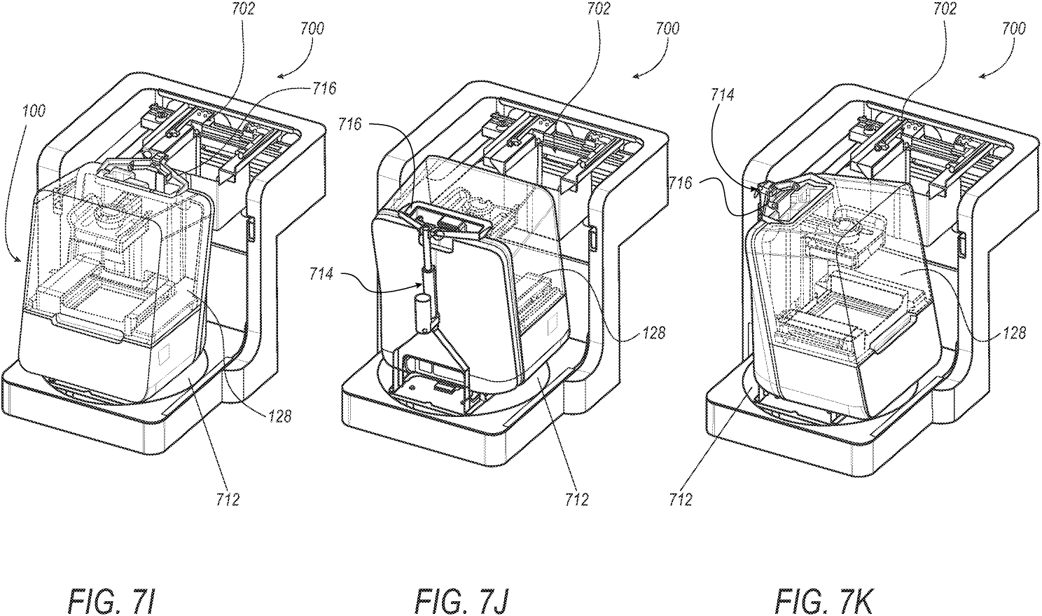

FIGS. 7A-7K depict an illustrative automated parts removal and collection device 700 for a post-processing system with an alternative design in various configurations, according to some examples. Comparing to the parts removal and collection device 200 of FIG. 2A, the device 700 has a compact design with a head assembly 702 configured to travel along rails or draw sliders on a top portion of side frames 704. The head assembly 702 is similar to the head assembly 204 described in previous sections of this application, with a collection device 706 (corresponding to the collection device 206 of FIG. 2A) and a release device 708 (corresponding to the release device 208 of FIG. 2A). Alternatively, the head assembly 702 may have a design configuration similar to the head assemblies 600, 600a described in FIGS. 6A-6D.

The device 700 also includes a pedestal assembly 710 that includes a turntable 712 and a printer cover opening device 714. FIG. 7B shows that an additive fabrication device 100 is coupled to the turntable 712 of the pedestal assembly 710 by any suitable means. The cover opening device 714 is attached to the top of the cover 128 of the additive fabrication device 100. As the cover opening device 714 extends or retracts, the cover opening device 714 causes the cover 128 to open or close by pivoting about hinges on the additive fabrication device 100. In some examples, the cover opening device 714 includes a decoupling mechanism 717 that allows the top frame 716 to be decoupled from the shaft 718 (e.g., an electric linear actuator) when a force exerted by the cover 128 is greater than a preset threshold (e.g., indicating that a foreign object may be introduced between the cover and the additive fabrication device 100 during closing. For example, the top frame 716 is typically magnetically coupled to the shaft 718, and moves as a single part with the shaft 718 during extension or retraction. However, when the force exerted by the cover 128 is greater than the preset threshold, the magnetic attraction between the shaft 718 and the top frame 716 is weaker than that required to continue extending the shaft 718. As a result, the top frame 716 decouples from the shaft 718 and is allowed to pivot freely with respect to the shaft 718. As the shaft 718 continues to extend, the cover is stationary as the pivot joints of each of the shaft 718 and the top frame 716 rotate with respect to each other.

FIGS. 7C and 7D show the movement of the head assembly 702 along linear rails (or sliders) attached on the inside of the side frames 704. As depicted in FIG. 7D, the head assembly 702 is at the parts collection location 504 and is configured to trigger parts release mechanism of the additive fabrication device 100. The head assembly 702 may subsequently collect the released printed objects.

FIGS. 7E and 7F illustrate the head assembly 702 traveling along the head rails to close and open the basket units 706a, 706b of the collection device 706 and the arms 708a, 708b of the release device 708.

FIGS. 7G and 7H show that the pedestal assembly 710 is configured to be folded into the mainframe of the device 700, such that the pedestal assembly 710 is foldable between a storage position and an operable position. For example, the cover opening device 714 is pivotally coupled to the base of the pedestal assembly 710, allowing the cover opening device 714 to be folded into the pedestal assembly 710. The pedestal assembly 710 is further pivotally coupled to the main body of the device 700, allowing the pedestal assembly 710 to be folded and placed in a vertical position.

FIGS. 7I-7K show that the additive fabrication device 100 can be rotated to face different orientations on the turntable 712. For example, the turntable 712 may be operable to orient an access portion 132 of the three-dimensional printer 100 sideways on the pedestal assembly 710 during printing. In some examples, the device 100 can be communicably coupled to the parts release and collection device 700. As a result, the device 700 is not required to have a separate control panel but can rely on the control panel 108 of the device 100. For example, during printing, the device 100 may be controlled to face sideways to give a user better access to the device 100 and the control panel 108. As the device 100 finishes printing, the turntable 712 rotates to orient the device 100 to face the head assembly 702. The cover opening device 714 then opens the cover, and the head assembly 702 moves into the device 100 for parts release and collection.

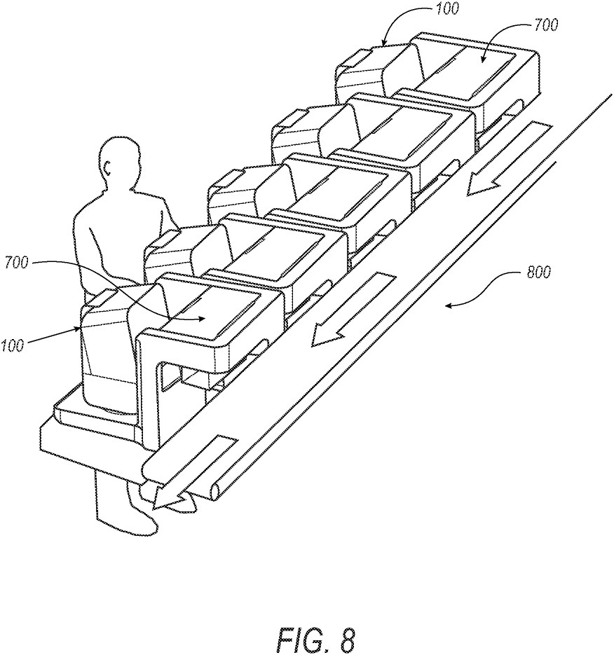

FIG. 8 depicts multiple parts removal and collection devices 700 coupled to a conveyor mechanism 800 for continuous parts printing and collection, according to some examples. The multiple parts removal and collection devices 700 can be placed in a line side-by-side, and each device 700 may be coupled to an additive fabrication device 100. Although not shown, bins or baskets may be placed on the conveyor mechanism 800 to collect the parts released under the head assembly 702. The collected parts can be transported to other devices for further processing, such as washing or curing.

What is claimed is:

1. A post-processing device configured to be coupled to a three-dimensional printer, the post-processing device comprising:
a head assembly comprising a release device and a collection device;
a rail extending in a first direction and having a parts collection location, wherein the head assembly is configured to travel along the rail;
a pedestal assembly configured to be coupled to a base of the three-dimensional printer; and
an opening device for opening a cover of the three-dimensional printer,
wherein at the parts collection location on the rail:
the release device of the head assembly is configured to engage with a build platform of the three-dimensional printer to release printed parts on the build platform; and
the collection device of the head assembly is below the build platform and is configured to collect the released printed parts.

2. The post-processing device of claim 1, wherein the release device comprises a first arm and a second arm that are each configured to travel along a second direction transverse to the first direction.

3. The post-processing device of claim 2, wherein the first arm and the second arm engage the build platform and translate towards each other in the second direction, and wherein the first arm and the second arm engage a release trigger of the build platform at the parts collection location.

4. The post-processing device of claim 2, wherein the collection device comprises a first basket unit and a second basket unit that are each configured to travel along the second direction.

5. The post-processing device of claim 4, wherein the first basket unit and the second basket unit are configured to travel towards each other to form a basket below the build platform when the head assembly is at the parts collection location.

6. The post-processing device of claim 4, wherein the first basket unit and the first arm form an integrated first part of the head assembly, and the second basket unit and the second arm form an integrated second part of the head assembly.

7. The post-processing device of claim 1, further comprising a storage device, wherein the collection device is configured to move to a parts storage location along the rail to drop the collected printed parts into the storage device.

8. The post-processing device of claim 1, wherein the pedestal assembly comprises a turntable configured to be coupled to the three-dimensional printer.

9. The post-processing device of claim 8, wherein the turntable is operable to orient an access portion of the three-dimensional printer sideways on the pedestal assembly during printing, and operable to orient the access portion of the three-dimensional printer toward the head assembly during parts removal and collection.

10. The post-processing device of claim 1, wherein the pedestal assembly is configured to be folded into the post-processing device.

11. The post-processing device of claim 1, wherein post-processing device is configured to be electrically coupled to the three-dimensional printer.

12. A parts removal and collection device for a post-processing system and operable with a three-dimensional printer, the parts removal and collection device comprising:
a head assembly including a release device and a collection device;
a rail extending in a first direction, wherein the head assembly is configured to travel along the rail, the release device of the head assembly engaged to release printed parts received by the collection device at a parts collection location along the rail;
a pedestal assembly configured to be coupled to a base of the three-dimensional printer; and
an opening device configured to be selectively coupled to a cover of the three-dimensional printer.

13. The parts removal and collection device of claim 12, wherein the release device of the head assembly includes a first arm and a second arm that are each operable along the rail in a second direction.

14. The parts removal and collection device of claim 13, wherein the first arm moves proximate to the second arm in the second direction, and wherein the first arm and the second arm are configured to engage a release trigger of the three-dimensional printer.

15. The parts removal and collection device of claim 12, wherein the collection device includes a first basket unit and a second basket unit each operable along the rail in a second direction.

16. The parts removal and collection device of claim 15, wherein the first basket unit and the second basket unit form a basket at the parts collection location.

17. The parts removal and collection device of claim 12, further comprising a storage device that receives the printed parts from the collection device at a parts storage location along the rail.

18. The parts removal and collection device of claim 12, wherein the pedestal assembly includes a turntable configured to receive and fixedly couple to the three-dimensional printer.

19. The parts removal and collection device of claim 18, wherein the pedestal assembly is foldable between a storage position and an operable position.

20. The parts removal and collection device of claim 12, wherein the parts removal and collection device is configured to be in electrical communication with the three-dimensional printer.
